(19) United States
(12) Patent Application Publication
(10) Pub. No.: US 2024/0331957 A1
(43) Pub. Date: Oct. 3, 2024

(54) Low Voltage Switch Pole

(71) Applicant: ABB S.p.A., Milano (IT)

(72) Inventors: Saugata Das, Hyderabad (IN); Hemant Anjaria, Hyderabad (IN); Giulio Tribulato, Bergamo (IT); Michele Ceroni, Bergamo (IT)

(73) Assignee: ABB S.p.A., Milano (IT)

(21) Appl. No.: 18/618,028

(22) Filed: Mar. 27, 2024

(30) Foreign Application Priority Data
Mar. 27, 2023 (EP) 23164401.4

(51) Int. Cl. H01H 9/30; H01H 1/22; H01H 9/34

(52) U.S. Cl. CPC H01H 9/302; H01H 1/226; H01H 9/34

(57) ABSTRACT

A switch pole for a low voltage switching device comprising an insulating casing defining an internal space with a contact region and an arc extinguishing region of the switch pole; a fixed contact assembly and a movable contact assembly positioned in the contact region and including, respectively, one or more fixed contacts and one or more movable contacts, which can be mutually coupled or uncoupled; a baffle arrangement including one or more sheets of insulating material arranged on the movable contact assembly in such a way to move together the movable contact assembly and be interposed between the support body and the front wall of the insulating casing.

### CROSS-REFERENCE TO RELATED APPLICATIONS

The instant application claims priority to European Patent Application No. 23164401.4, filed Mar. 27, 2023, which is incorporated herein in its entirety by reference.

### FIELD OF THE DISCLOSURE

The present disclosure relates to a switch pole for a switching device suitable for installation in low-voltage electrical systems, and to a switching device comprising one or more of the switch poles.

### BACKGROUND OF THE INVENTION

Low voltage switching devices, such as circuit breakers, disconnectors, contactors, or the like, comprise one or more switch poles, each including one or more fixed contacts and movable contacts that can be coupled to and uncoupled from one another.

These devices also comprise driving means mechanically coupled to the movable contacts to move these latter relative to the fixed contacts, so that these electric contacts can be mutually coupled or uncoupled to allow or prevent electric currents to flow along the switch poles. Such driving means comprise, for instance, suitable mechanisms terminating in a shaft operatively connected to the movable contacts.

Switching devices currently available on the market have still some aspects to improve. When they are brought to operate at relatively high voltage levels (e.g., about 1.2-1.5 kV either AC or DC), as it frequently occurs in modem electric power distribution grids, during opening manoeuvres, undesired arcing phenomena are often observed to arise between some conductive parts of the switch poles, which are located outside the arc-extinguishing region.

Such undesired arcing phenomena may occur between some conductive parts of the movable contact assembly (for example the connection braids between the movable contact and the corresponding pole terminal) and the connecting rod mechanically the movable contact assembly to the above-mentioned driving mechanisms.

Dangerous arcing currents may therefore flow through the connecting rods of the switch poles (normally put at a ground voltage) and propagate to the driving mechanisms connected thereto. Obviously, these events may lead to serious damages since the affected components are not generally designed to bear high electric and thermal stresses.

Experimental tests have also proven that the above-mentioned undesired arcing phenomena are promoted by the circumstance that, during opening manoeuvres, a portion of the hot gases formed in the arc-extinguishing region of the switch pole may undesirably leak through the opening of the pole casing, which is typically arranged to allow the passage of the connecting rod of the movable contact assembly to the outside for being mechanically connected to the related driving mechanism.

### BRIEF SUMMARY OF THE INVENTION

The present disclosure generally describes a switch pole for low voltage switching devices, which allows overcoming or mitigating the above-mentioned shortcomings. In particular, the present disclosure describes a switch pole, in which arcing phenomena between conductive parts outside the arc-extinguishing region of the switch pole are prevented or remarkably limited during opening manoeuvres of the switch pole.

Another embodiment of the present disclosure describes a switch pole, in which undesired leaks of hot gases out of the switch pole are avoided or remarkably reduced during opening manoeuvres of the switch pole. A further embodiment of the present disclosure is to provide a switch pole that is reliable in operation and relatively easy and cheap to manufacture at industrial level.

The above aim and purposes, as well as other purposes that will emerge clearly from the following description and attached drawings, are provided, according to the disclosure, by a switch pole for a low voltage switching device, according to the following claim 1 and the related dependent claims.

In a general definition, the switch pole, according to the invention comprises an insulating casing, which defines an internal space including a contact region and an arc extinguishing region. The switch pole, according to the invention, further comprises a fixed contact assembly and a movable contact assembly positioned in the contact region of the switch pole. The fixed contact assembly and the movable contact assembly include, respectively, one or more fixed contacts and one or more movable contacts, which can be mutually coupled or uncoupled. In one embodiment, the one or more fixed contacts are arranged at a rear wall of the insulating casing.

The movable contact assembly of the switch pole is reversibly movable between a first position, in which the movable contacts are coupled to the fixed contacts, and a second position, in which the movable contacts are spaced apart from the fixed contacts. The movable contact assembly comprises a support body configured to support the movable contacts. The support body has a first side facing the front wall of the insulating casing, and a second side facing the rear wall of the insulating casing. The one or more movable contacts of the movable contact assembly are arranged at the second side of the support body.

The movable contact assembly comprises a connecting rod fixed to the support body and mechanically couplable to a driving mechanism of the movable contact assembly outside the switch pole. The connecting rod protrudes from the first side of the support body and sticks out of the insulating casing of the switch pole by passing through a front window of the front wall of the insulating casing.

### BRIEF DESCRIPTION OF THE SEVERAL VIEWS OF THE DRAWING(S)

Further features and advantages of the present invention will be evident from the description of preferred but not exclusive embodiments of a switch pole shown by way of examples in the accompanying drawings.

FIGS. 1 and 2 are schematic views of a low voltage switching device comprising a plurality of low voltage switch poles in accordance with the disclosure.

FIG. 3 is a schematic exploded view of a switch pole in accordance with the disclosure.

FIG. 4 is a partial view of a switch pole, in which only the movable contact assembly (without a baffle arrangement) is shown in accordance with the disclosure.

FIGS. 5 and 6 are schematic views of a switch pole, according to different embodiments of the present disclosure.

FIGS. 7, 8, and 9, are schematic views the switch pole, according to the embodiment of FIG. 6, in different operating conditions.

### DETAILED DESCRIPTION OF THE INVENTION

With reference to the attached figures, the present invention relates to a switch pole 1 for a low voltage switching device 100, e.g., a circuit breaker, a disconnector, a contactor, or the like. The switching device 100 is particularly adapted for use in AC low voltage electrical systems and it will be described with reference to these applications. However, in principle, it may be used also in electric systems of different type, e.g., in DC low voltage electrical systems. For the purposes of the present invention, the term “low voltage” typically relates to operating voltages up to 1.5 kV AC and 2 kV DC. The switching device 100 comprises one or more switch poles 1, according to the invention.

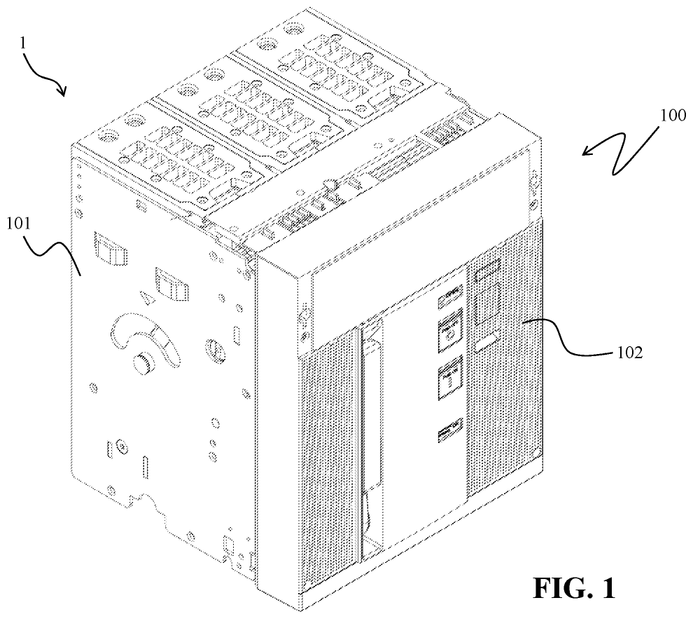

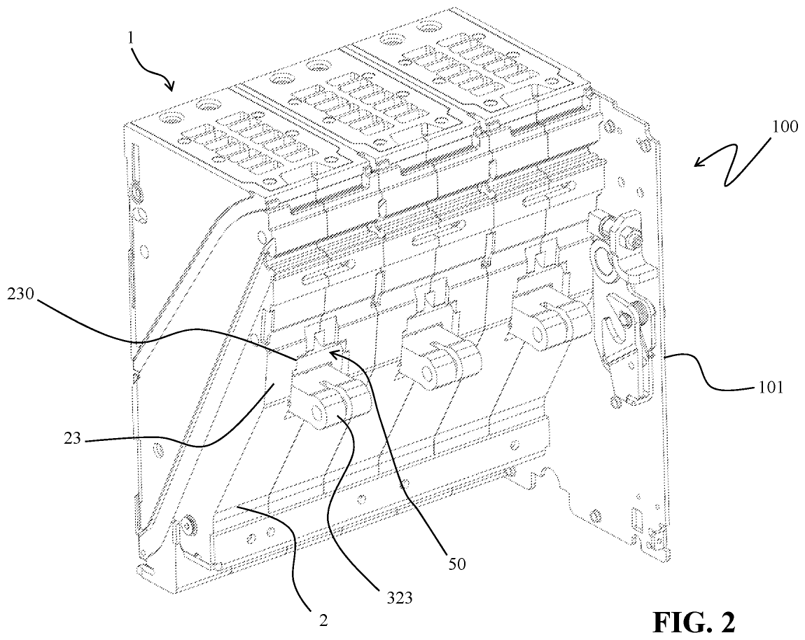

The number of switch poles may vary, according to the needs. In the embodiments shown in FIGS. 1-2, the switching device 100 is of the three-phase type and it comprises three switch poles. However, according to other embodiments of the invention (not shown), the switching device 100 may include a different number of switch poles depending on the number of electric phases of the electric circuit, in which it must be installed.

Each switch pole 1 of the switching device 100 comprises an insulating casing 2, which preferably defines an internal volume including a contact region 3 and an arc extinguishing region 4. In general, the contact region 3 is a portion of internal volume of the switch pole where the electric contacts of the switch pole are arranged and operate. On the other hand, the arc-extinguishing region 4 is a portion of internal volume of the switch pole where there are arranged arc-quenching means 41 designed to extinguish possible electric arcs arising between the electric contacts of the switch pole, during the opening maneuvers of the switching device.

As shown in the cited figures, the contact region 3 and the arc extinguishing region 4 of the switch pole are adjacent and in fluid-dynamic communication one with another. Preferably, the arc extinguishing region 4 is positioned at un upper level with respect to the contact region 3, i.e., in proximal position relative to a top side of this latter.

For the sake of clarity, it is specified that relative terms used in this disclosure, e.g., “front”, “rear”, “lateral”, “upper”, “lower”, “top” and “bottom” relate to the switch pole 1 in its normal installation conditions, namely in the vertical installation shown in FIGS. 1-2.

The insulating casing 2 of the switch pole is shaped as a contoured box with opposite first and second lateral walls 21, 22, opposite front and rear walls 23, 24 and opposite top and bottom walls 25, 26.

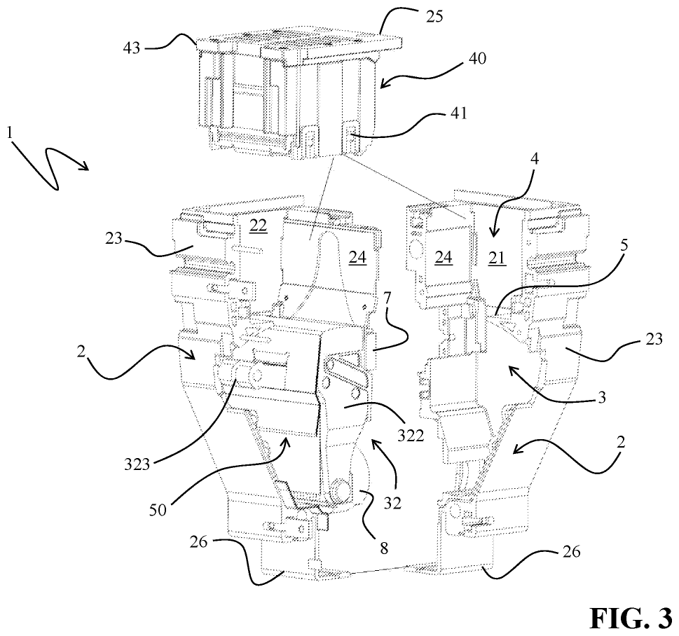

As shown in FIG. 3, the insulating casing 2 is preferably formed by first and second half shells coupled one to another. In practice, a first half shell comprises the first lateral wall 21, a portion of the front wall 23, a portion of the rear wall 24 and a portion of the bottom wall 26, while a second half shell comprises the second lateral wall 22, a portion of the front wall 23, a portion of the rear wall 24 and a portion of the bottom wall 26.

According to these embodiments of the invention, the top wall 25 of the insulating casing 2 is fixed to a further insulating enclosure 43 of another component (the arc chamber 40) of the switch pole and it may be removably installed in the switch pole together with such a component (FIG. 3). However, according to other embodiments of the invention (not shown), the insulating casing 2 of the switch pole may be arranged differently. For example, the top wall of the insulating casing may be integral with other walls of the insulating casing, or it may be self-standing so as to be removably coupleable with other walls of the insulating casing.

Preferably, the top wall 25 of the insulating casing 2 is provided with several through openings to allow the exit of hot gases from the internal space of the switch pole, namely from the arc extinguishing region 4, during an opening maneuver of the switching device.

According to some embodiments (shown in the cited figures), the insulating casing 2 comprises an insulating wall 5, which partially separates the contact region 3 from the arc extinguishing region 4.

Conveniently, the insulating wall 5 defines an insulating boundary between the contact region 3 and the arc extinguishing region 4 at the front wall 23 of the insulating casing 2 while the contact region 3 and the arc extinguishing region 4 remain in direct fluid-dynamic communication at the rear wall 24 of the insulating casing 2. This solution greatly helps to confine the electric arcs in the arc-extinguishing region 4 of the switch pole during opening maneuvers.

The insulating casing 2 is made of an electrically insulating material, e.g., a thermosetting or thermoplastic material. Advantageously, the switch pole 1 comprises a first pole terminal 7 and a second pole terminal 8. In operation, the pole terminals 7, 8 are electrically coupled with corresponding line conductors of an electric line. Such line conductors are, in turn, electrically connected to an electric power source (e.g., an electric power feeding or generation system or a section of electric grid) and to an electric load (e.g., an electric system or apparatus or a section of electric grid).

Preferably, the pole terminals 7, 8 are positioned at the rear wall 24 of the insulating casing 2 of the switch pole. In general, the pole terminals 7, 8 may be realized according to solutions of known type and it will be described hereinafter only with reference to the aspects of interest of the invention, for the sake of brevity. The switch pole 1 comprises a fixed contact assembly 31 and a movable contact assembly 32, which are positioned in the contact region 3 of the switch pole. The fixed contact assembly 31 comprises one or more fixed contacts 311, which are electrically connected to the first pole terminal 7 of the switch pole.

Preferably, the fixed contacts 311 are positioned at the rear wall 24 of the insulating casing 2, advantageously in proximal position relative to the arc-extinguishing region 4 of the switch pole.

Preferably, the fixed contacts 311 are formed by suitable conductive plates.

In the embodiments shown in the cited figures, the fixed contact assembly 31 comprises a pair of fixed contacts 311 (conductive tips or plates). However, according to other embodiments of the invention (not shown), the fixed contact assembly 31 may include a different number of electric contacts.

In general, the fixed contact assembly 31 may be realized according to solutions of known type and it will be described hereinafter only with reference to the aspects of interest of the invention, for the sake of brevity.

The movable contact assembly 32 comprises one or more movable contacts 321, which are electrically connected to the second pole terminal 8 of the switch pole.

Preferably, the movable contacts 321 are formed by suitable conductive fingers.

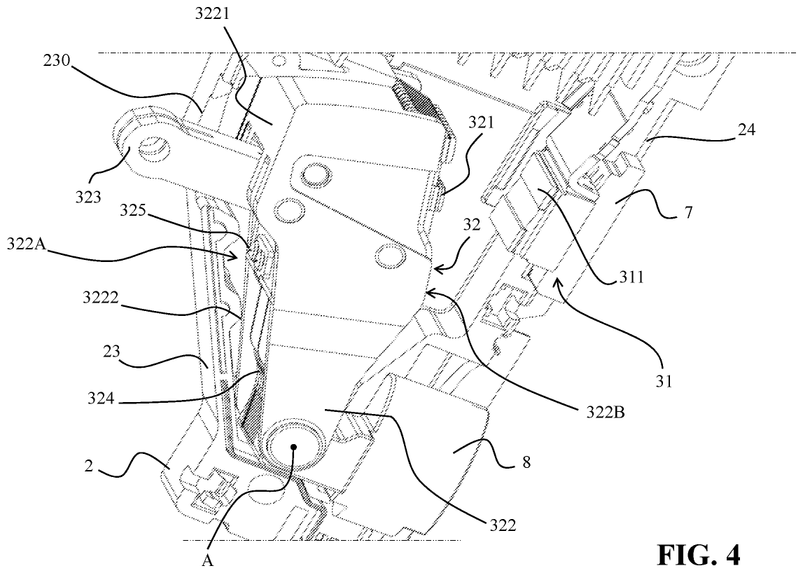

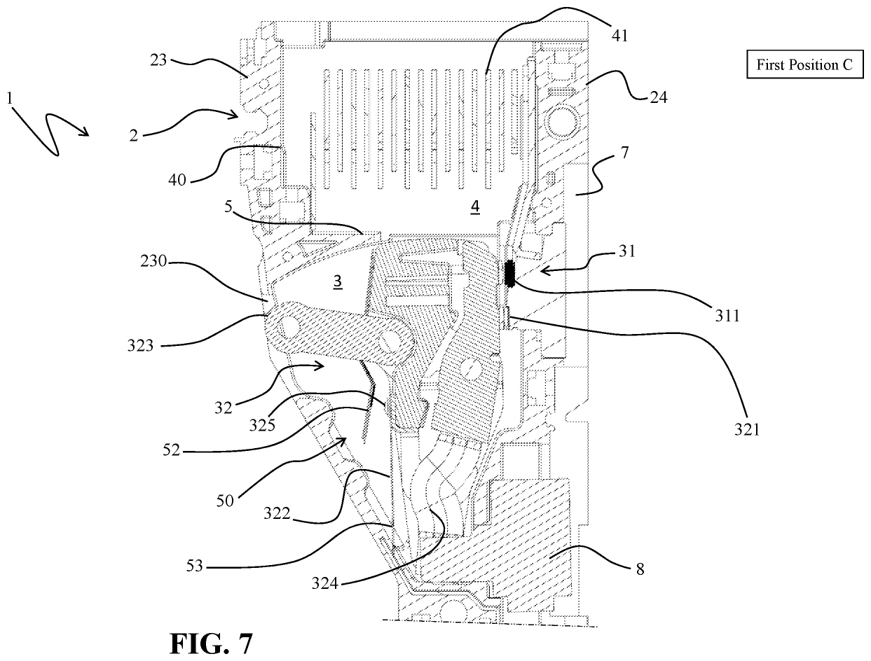

The movable contacts 321 can be mutually coupled or uncoupled to the fixed contacts 311. To this aim, the movable contact assembly 32 is reversibly movable about a rotation axis A (FIG. 4). Referring to FIGS. 7-9, the rotation axis A of the movable contact assembly 32 is perpendicular to the observation plane of these figures. In practice, it is parallel to the front and rear walls 23, 24 and perpendicular to the lateral walls 21, 22 of the insulating casing 2.

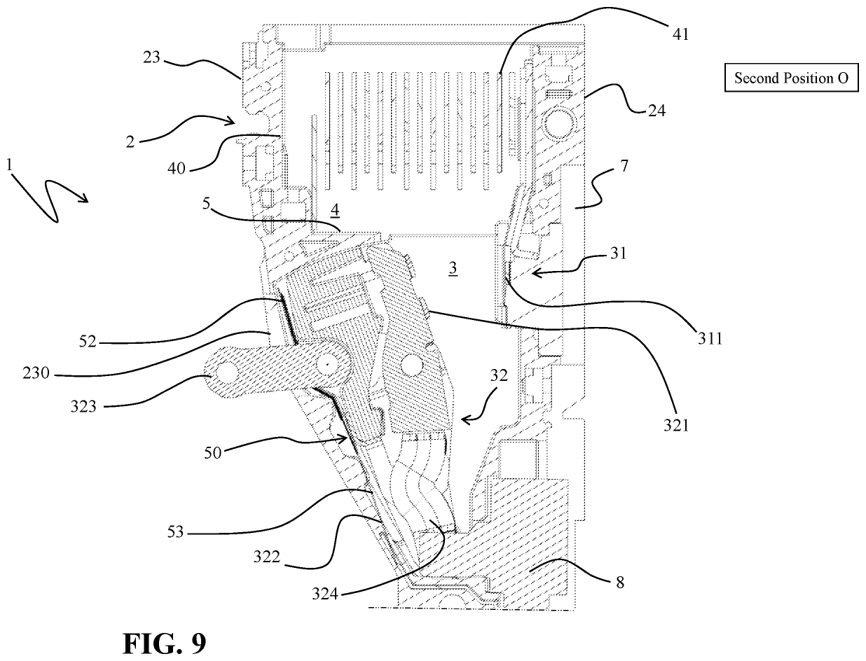

The movable contact assembly 32 is reversibly movable between a first position C (FIG. 7), in which the movable contacts 321 are coupled to the fixed contacts 311, and second position O (FIG. 9), in which the movable contacts 321 are distally spaced from the fixed contacts 311.

The first position C of the movable contacts 321 of each switch pole corresponds to a closed condition of the switching device 100 (and of each switch pole), in which electric currents are allowed to flow along the electric poles whereas the second position O of the movable contacts 321 of each electric pole corresponds to an open condition of the switching device 100 (and of each switch pole), in which electric currents along the electric poles are interrupted.

A transition of the movable contacts 321 of each switch pole from the above-mentioned first position to the above-mentioned second position constitute an opening maneuver of the switching device 100 (and of each switch pole) whereas an opposite transition of the movable contacts 321 of each switch pole from the above-mentioned second position to the above-mentioned first position constitute a closing maneuver of the switching device 100 (and of each switch pole).

In the embodiments shown in the cited figures, the movable contact assembly 32 comprises a pair of movable contacts 321. However, according to other embodiments of the invention (not shown), the movable contact assembly 32 may include a different number of electric contacts.

The movable contact assembly 32 comprises a support body 322, preferably made of electrically insulating material, e.g., a thermosetting material.

The support body 322 is rotatably coupled to the insulating casing 2 of the switch pole and it can rotate about the rotation axis A to allow coupling or separation of the movable contacts 321 to or from the corresponding fixed contacts 311 of the fixed contact assembly 31.

The support body 322 supports the movable contacts 321 and one or more electrical connections 324 between the second pole terminal 8 and the movable contacts 321.

Preferably, the electrical connections 324 are formed by flexible conductive braids.

The movable contact assembly 32 comprises a connecting rod 323 (partially shown in the cited figures), which is fixed to the support body 322. In operation, the connecting rod 323 is mechanically coupled to a corresponding driving mechanism (not shown) located outside the switch pole.

The connecting rod 323 protrudes from the support body 322 and it sticks out of the insulating casing 2 of the switch pole by passing through a front window 230 of the front wall 23 of the insulating casing 2.

The support body 322 has a first side 322A facing the front wall 23 of the insulating casing and a second side 322B facing the rear wall 23 of the insulating casing (FIG. 4).

The support body 322 comprises, at the first side 322A, a first side region 3221, from which the connecting rod 323 protrudes towards the front window 230 of the insulating casing 2 and the outer environment, and a second side region 3222, at which the above-mentioned electrical connections 324 (and possibly other conductive parts 325) are arranged.

Advantageously, the first side region 3221 and the second side region 3222 of the support body 322 are arranged upwardly and downwardly relative the support body 322, i.e., in proximal position and in distal position relative to the arc-extinguishing region 4 of the switch pole.

The movable contacts 321 of the switch pole are arranged at the second side 322B of the support body 322. Conveniently, they are arranged upwardly relative to the support body 322, i.e., in proximal position relative to the arc-extinguishing region 4 of the switch pole in such a way to face the corresponding fixed contacts 311.

In general, the movable contact assembly 32 may be realized according to solutions of known type and it will be described hereinafter only with reference to the aspects of interest of the invention, for the sake of brevity.

According to the embodiments shown in the cited figures, the switch pole 1 comprises an arc chamber 40 positioned in the arc extinguishing region 4 of the switch pole, conveniently above the contact region 3.

The arc chamber 40 preferably comprises a plurality of arc-breaking elements 41 designed to extinguish possible electric arcs raising between the electric contacts 311, 321 of the switch pole when these latter are separating during an opening maneuver of the switching device 100.

The arc-breaking elements 41 of the arc chamber 40 are preferably formed by arc-breaking plates arranged in parallel one to another, preferably along reference planes parallel to the front and rear walls 23, 24 of the insulating casing 2. The arc-breaking plates 41 are advantageously arranged at subsequent positions between the front and rear walls 23, 24 of the insulating casing 2, at increasing distances from the rear wall 24.

Preferably, the arc chamber 40 is formed by a self-standing structure that can be removably installed in the corresponding switch pole. In this case, the arc chamber 40 preferably comprises an insulating enclosure 43 (made of an electrically insulating material, e.g., a thermosetting or thermoplastic material), which can be removably fixed to the insulating casing 2. The arc-breaking elements 41 are conveniently fixed to the insulating enclosure 43.

Preferably, the top wall 25 of the insulating casing 2 is fixed to the insulating casing 43 of the arc chamber 40. In this way, it can be installed or removed together with the arc chamber 40.

According to other embodiments of the invention (not shown), however, the arc chamber 40 may be simply formed by a sub-portion of the arc extinguishing region 4 of the switch pole, in which the arc-breaking elements 41 are arranged, for example by fixing them to the top wall 25 of the insulating casing 2 through suitable supports.

In general, the arc chamber 40 may be realized according to solutions of known type and it will be described hereinafter only with reference to the aspects of interest of the invention, for the sake of brevity.

According to the invention, the switch pole 1 comprises a baffle arrangement 50 including one or more sheets 51, 52, 53 of electrically insulating material, e.g., made of a plastic material, paperboard, glass fiber, and the like.

The sheets of insulating material 51, 52, 53 are arranged on the movable contact assembly 32 in such a way to move together with this latter and be interposed between the support body 322 of the movable contact assembly and the front wall 23 of the insulating casing 2.

The baffle arrangement 50 is configured to form an insulating dielectric barrier between one or more conductive parts 324, 325 of the movable contact assembly 32 and the connecting rod 323. The baffle arrangement can thus isolate electrically the conductive parts 324, 325 of the movable contact assembly 32 (especially the electrical connections 324) from the connecting rod 323. In this way, the probability that undesired electric arcs strike between the conductive parts 324, 325 and the connecting rod 323, during an opening maneuver of the switching device, is prevented or drastically limited.

The baffle arrangement 50 is also configured to obstruct, at least partially, the front window 230 of the insulating casing 2 at least when the movable contact assembly 32 reaches the above-mentioned second position O, during an opening maneuver of the switching device.

Preferably, one or more sheets of insulating material 51, 52 obstruct the portions of the front window 230 surrounding the connecting rod 323.

The baffle arrangement 50 can thus segregate the internal volume of the switch pole from the outside environment, at the front window 230, during an opening maneuver of the switching device.

In this way, it is possible to limit effectively leaks of hot gases through the front window 230, thereby further reducing the probability of having arcing phenomena between the conductive parts 324, 325 of the movable contact assembly 32 and the connecting rod 323.

On the other hand, a more efficient confinement of hot gases within the arc-extinguishing region 4 favors the flow of hot gases through the arc chamber 40 towards the openings of the top wall 25 of the insulating casing. Electric arcs forming between the electric contacts 311, 321 under separation, during an opening maneuver of the switching device are thus forced more effectively to develop along the arc chamber 40 (thereby involving a number of arc-breaker plates 41), which circumstance greatly favors the extinction of the electric arcs.

According to some embodiments of the invention, the baffle arrangement 50 is configured to obstruct, at least partially, the front window 230, also when the opening maneuver of the switching device is not completed yet, before the movable contact assembly 32 reaches the above-mentioned second position O.

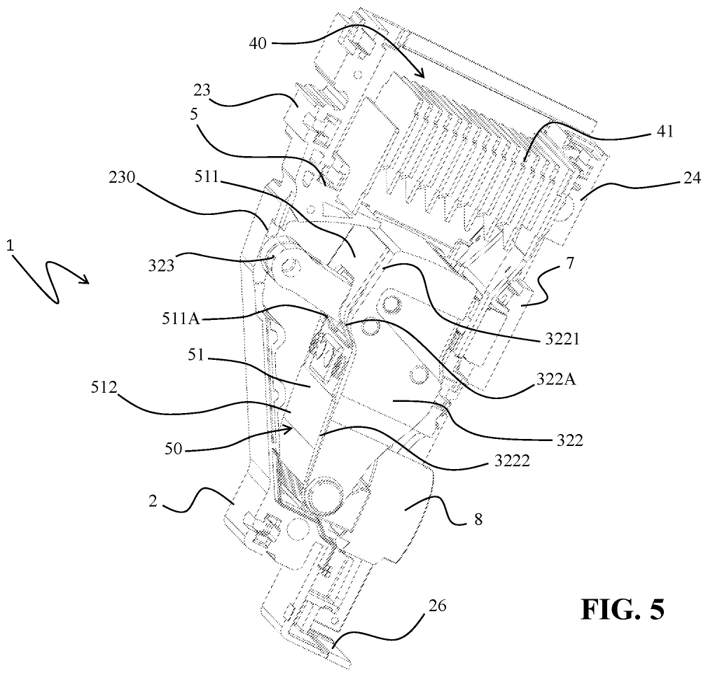

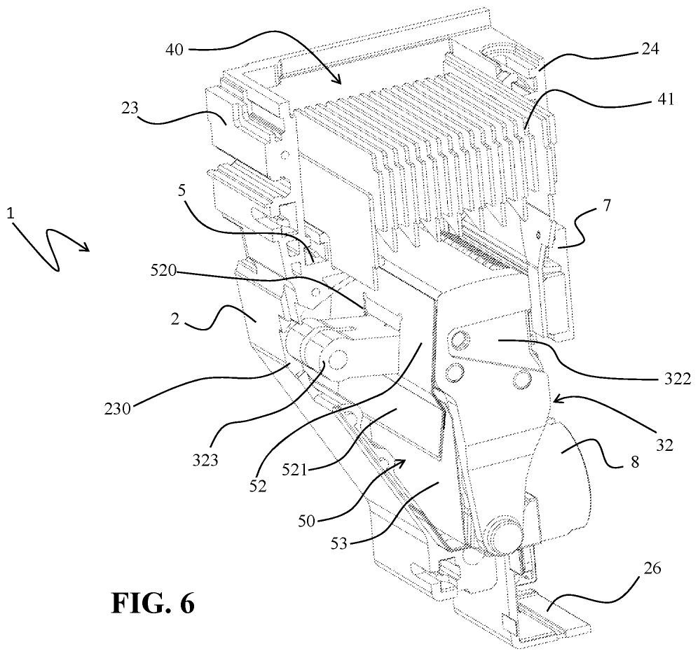

This solution allows confining more efficiently hot gases in the internal volume of the switch pole. According to some embodiments of the invention (FIGS. 5 and 6), the baffle arrangement 50 comprises one or more sheets 51, 53 of insulating material fixed to the support body 322 at the first side 322A of this latter in such a way to form one piece with the movable contact assembly. These fixed sheets 51, 53 of insulating material move solidly (i.e., as one piece) with the movable contact assembly 32, when this latter moves during the maneuvers of the switching device.

According to some embodiments of the invention (FIG. 6), the baffle arrangement 50 comprises one or more sheets 52 of insulating material mounted on the connecting rod 323 at the first side 322A of the support body 322 in such a way to be movable relative to the movable contact assembly 32. These movable sheets 52 of insulating material generally move together with the movable contact assembly 32 during the maneuvers of the switching device. However, under certain circumstances, they can move relative to the movable contact assembly 32.

Particularly, during an opening maneuver of the switching device, these movable sheets 52 of insulating material are pushed towards the front window 230 of the insulating casing 2 by the pressure exerted by hot gases flowing towards the front window 230. The sheets 52 of insulating material thus slide along the connecting rod 323 and reach the front wall 23, while the movable contact assembly 32 is still moving. They can thus obstruct the front window 230 before the movable contact assembly 32 reaches the second position O.

As shown in FIG. 6, the baffle arrangement 50 may comprise the above-mentioned movable sheets 52 of insulating material in addition to one or more fixed sheets 53 of insulating material. According to other variants (not shown), however, the baffle arrangement 50 may comprise only the above-mentioned movable sheets 52 of insulating material.

The one or more sheets 51, 52, 53 of insulating material are sandwiched between the first side 322A of the support body 322 and the front wall 23 of the insulating casing 2, when the movable contact assembly 32 reaches the second position O. Conveniently, the 51, 52, 53 of insulating material are structurally flexible to conform better to the profile of the front wall 23.

FIG. 5 shows an embodiment of the invention, in which the baffle arrangement 50 comprises a single first sheet 51 of insulating material (e.g., a thermoplastic material) fixed on the support body 322 of the movable contact assembly.

Preferably, the first sheet of insulating material 51 has a shape complementary to the profile of the first side 322A of the support body 322 in such a way to follow the outer surface of this latter. In this way, the first sheet of insulating material 51 does not limit the rotation angle of the movable contact assembly 32 when it is sandwiched between the movable contact assembly and the front wall 23 of the insulating casing.

Preferably, the first sheet of insulating material 51 has a deformable structure to conform better to the profile of the front wall 23 when it is sandwiched between the movable contact assembly 32 and the front wall 23.

The first sheet of insulating material 51 comprises a first sheet portion 511 covering the first side region 3221 of the support body 322 and fixed to this latter through suitable screws or equivalent mechanical connection means. Advantageously, the first sheet portion 511 comprises a hole 511A for the passage of the connecting rod 323, which protrudes from the support body 322.

Conveniently, when the movable contact assembly 32 reaches the above-mentioned second position corresponding to an open condition of the switching device 100, the first sheet portion 511 obstructs at least partially the front window 230 of the insulating casing 2, thereby segregating the internal volume of the switch pole from the outer environment at the front window 230.

Preferably, the first sheet portion 511 obstructs the portions of front widow 230, which surround the connecting rod 323 and which are left free by the connecting rod 323, when this latter passes through the front window 230.

The first sheet of insulating material 51 additionally comprises a second sheet portion 512 covering the second side region 3222 of the support body 322, at which the electrical connections 324 are arranged. The second sheet portion 512 is fixed to the support body 322 through suitable screws or equivalent mechanical connection means.

The second sheet portion 512 is interposed between the electrical connections 324 and the connecting rod 323, thereby electrically insulating this latter from the electrical connections.

FIG. 6 shows another embodiment of the invention. In this case, the baffle arrangement 50 comprises a plurality of second sheets 52 of insulating material (e.g., made of paperboard or fiber glass) covering the first side region 3221 of the support body 322.

The second sheets 52 of insulating material are mounted on the connecting rod 323 at the first side 322A of the support body 322 and are not fixed to the support body 322 so that they can move relative to the movable contact assembly 32 while they move together with this latter, particularly during an opening maneuver of the switching device.

Preferably, they are provided with a suitable hole or aperture 520, through which the connecting rod 323 is inserted. In this way, they can be easily stacked one on another along the connecting rod.

As in the embodiment described above, the second sheets 52 of insulating material obstruct at least partially the front window 230 of the insulating casing 2, when the movable contact assembly 32 reaches the above-mentioned second position during an opening maneuver of the switching device. However, during the opening maneuver, one or more second sheets 52 of insulating material are pushed towards the front window 230 of the insulating casing 2 by the incoming hot gases and obstruct at least partially the front window 230 also before the opening maneuver is completed.

Preferably, the second sheets 52 of insulating material have a shape complementary to the profile of the support body 322 at the first side region 3221 of the support body.

Preferably, the second sheets of insulating material 52 have a deformable structure to conform better to the profile of the front wall 23 when they are sandwiched between the movable contact assembly 32 and the front wall 23.

In the embodiment of FIG. 6, the baffle arrangement 50 further comprises a third sheet 53 of insulating material (e.g. made of a thermoplastic material) fixed to the support body 322 at the first side 322A of the support body.

The third sheet 53 of insulating material covers the second side region 3222 of the support body 322 and it is interposed between the electrical connections 324 and the connected rod 324, thereby electrically insulating this latter from the electrical connections.

The third sheet 53 of insulating material is fixed to the support body 322 through suitable screws or equivalent mechanical connection means.

Preferably, also the third sheet of insulating material 53 has a deformable structure to conform better to the profile of the front wall 23 when it is sandwiched between the movable contact assembly 32 and the front wall 23.

Preferably, the second sheets 52 of insulating material have lower free ends 521 partially overlapping with the third sheet 53 of insulating material in such a way to be interposed between the third sheet 53 of insulating material and the connecting rid 323.

This solution is quite useful as it allows simplifying the overall structure of the movable contact assembly 32. In fact, connection elements 325 (e.g., screws), which are typically employed to support live parts (e.g. one or more partitioning members of the electrical connections 324, which are fixed to the support body 322—FIGS. 4 and 7-8) of the movable contact assembly, may be used also for fixing the third sheet 53 of insulating material to the support body 322 without jeopardizing the electrical insulation of the connecting rod 323.

FIGS. 7-9 show the behavior of the switch pole 1, according to the embodiment of FIG. 6, during an opening maneuver of the switching device 100.

FIG. 7 shows the switch pole with the movable contact assembly in the first position C.

The movable contacts 321 are electrically and mechanically coupled to the fixed contacts 311.

In this situation, a current can flow along the switch pole between the pole terminals 7, 8. No electric arcs develop between the above-mentioned electric contacts 311, 321.

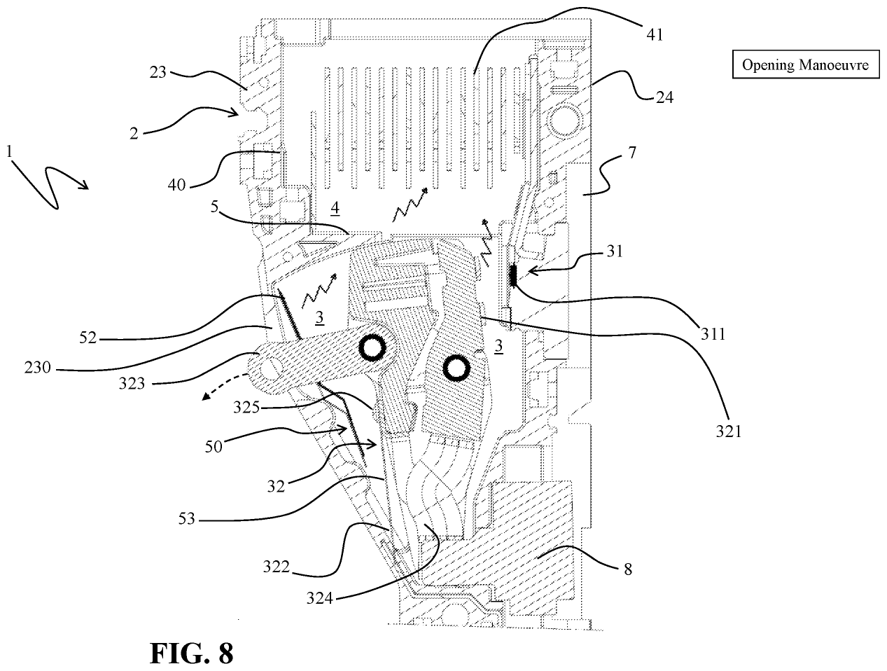

During an opening maneuver, the movable contact assembly 32 rotates about the rotation axis A and the movable contacts 321 are moved away from the fixed contacts 311 (FIG. 8—dotted arrow).

As soon as the movable contacts 321 separate from the fixed contacts 311, a difference of voltage potential is established between the electric contacts (at any time, the movable contacts 321 may have a positive voltage polarity while the fixed contacts 311 may have a negative voltage polarity, or vice-versa). Since the dielectric distance between the electric contacts 311, 321 increases, electric arcs develop between the electric contacts. The high energy ionization effects of the dielectric medium (air) between the electric contacts 311, 321 leads to the generation of high-pressure hot gases, a portion of which starts flowing towards the front window 230 of the insulating casing 2.

Due to the pressure exerted by the hot gases, the second sheets 52 of insulating are pushed towards the front window 230. The second sheets 52 of insulating slide along the connecting rod 323, while the movable contact assembly 32 is moving, and obstruct the front window 230 before the movable contact assembly 32 (FIG. 8). The hot gases cannot flow through the front window 230 and return towards the arc extinguishing region 4 of the switch pole.

In the meanwhile, both the second and third sheets 52, 53 of insulating material electrically insulate the live parts 324, 325 of the movable contact assembly from the connecting rod 323.

Finally, when the movable contact assembly 32 reaches the second position O, electric arcs may be finally quenched (FIG. 9) or continue their quenching process through the arc-chamber 40.

When the movable contact assembly 32 reaches the second position O, both the second and third sheets 52, 53 of insulating material are sandwiched between the first side 322A of the support body 322 and front wall 23 of the insulating casing. The second sheets 52 of insulating material obstruct the front window 230 while both the second and third sheets 52, 53 of insulating material still electrically insulate the live parts 324, 325 of the movable contact assembly from the connecting rod 323.

The operation of the switch pole 1 according to the embodiment of FIG. 5 is quite similar. In this case, however, the first sheet 51 of insulating material does not move relative to the movable contact assembly 32 as it is fixed to the support body 322.

As the skilled person will certainly understand, the switch pole, according to the invention, may be subject to modifications or variations all falling within the scope of the inventive concept as defined by the appended claims.

For example, according to a possible variant of the embodiment of FIG. 5, the baffle arrangement 50 may include a plurality of overlapped sheets 51 of insulating material fixed to the support body 322 of the movable contact assembly.

As a further example, according to possible variants of the embodiment of FIG. 6, the baffle arrangement 50 may include a single sheet 52 of insulating material movably mounted on the connecting rod 323 and/or a plurality of overlapped sheets 53 of insulating material fixed to the support body 322 of the movable contact assembly.

The low voltage switch pole, according to the present invention, allow the proposed aims and the objects to be achieved.

By virtue of the baffle arrangement 50, in the switch pole, according to the present invention, the connecting rod 323 is electrically insulated from other conductive parts 324, 325 of the movable contact assembly 32. At the same time, possible leaks of hot gases through the front window 230 of the insulating casing 2 are prevented or drastically limited.

The formation of undesired arcing phenomena between the conductive parts 324, 325 and the connecting rod 323 is thus prevented or remarkably reduced in comparison to the available solutions of the state of the art.

Despite of the presence of the baffle arrangement 50, the switch pole 1 has a compact and simple structure. The switch pole 1 is thus relatively easy and cheap to manufacture at industrial level, at competitive costs with the available solutions of the state of the art.

As mentioned above, the present invention relates also to a low voltage switching device 100 comprising one or more low voltage switch poles 1 as previously described.

With reference to FIGS. 1 and 2, a three-pole low voltage circuit breaker 100 comprising three low voltage switch poles 1 is shown.

In this embodiment, the insulating casing 2 of each switch pole 1 is made of two half shells, and the switch poles 1 are positioned side by side in a supporting structure having rigid flanks 101 as well as a cover portion 102.

From suitable front windows 230 at the front wall 23 of the insulating casing 2 of each switch pole 1, connecting rods 323 protrude for mechanical connection with a driving mechanism (not shown). As it is possible to notice from FIG. 2, the baffle arrangement 50 of each switch pole obstructs the front window 230 of the corresponding insulating casing 2, when the switching device 100 has reached an open condition (as shown in FIG. 2).

The general structure of the low voltage circuit breaker 100 is, in many aspects, well known in the art and therefore it will not be described here in more details, for the sake of brevity.

Preferably, the switch pole may further comprise an arc chamber positioned in the arc extinguishing region of the switch pole. The arc chamber comprises a plurality of arc-breaking elements, which are preferably formed by arc-breaking plates.

According to the invention, the switch pole comprises a baffle arrangement including one or more sheets of insulating material mounted on the movable contact assembly at the first side of the support body of the movable contact assembly.

The one or more sheets of insulating material move together with the movable contact assembly and are interposed between the support body of the movable contact assembly and the front wall of the insulating casing of the switch pole.

The one or more sheets of insulating material form an insulating dielectric barrier between one or more conductive parts and the connecting rod of the movable contact assembly.

The one or more sheets of insulating material obstruct at least partially the front window of the insulating casing of the switch pole, at least when the movable contact assembly reaches the second position during an opening maneuver of the switching device.

According to some embodiments of the invention, the one or more sheets of insulating material obstruct at least partially the front window, also before the movable contact assembly reaches the second position during an opening maneuver of the switching device.

According to some embodiments of the invention, the baffle arrangement comprises one or more sheets of insulating material fixed to the support body of the movable contact assembly at the first side of the support body.

According to some embodiments of the invention, the baffle arrangement comprises one or more sheets of insulating material mounted on the connecting rod at the first side of the support body of the movable contact assembly in such a way to be movable relative to the movable contact assembly.

According to an embodiment of the invention, the baffle arrangement comprises a first sheet of insulating material fixed to the support body of the movable contact assembly at the first side of the support body. The first sheet of insulating material has a first sheet portion covering a first side region of the support body, from which the connecting rod protrudes, and a second sheet portion covering a second side region of the support body, at which conductive parts of the movable contact assembly are arranged.

Preferably, the first sheet of insulating material has a shape complementary to a profile of the support body at the first side of the support body, namely at the first and second side regions. According to another embodiment of the invention, the baffle arrangement comprises a plurality of second sheets of insulating material mounted on the connecting rod of the movable contact assembly and a third sheet of insulating material fixed to the support body, at the first side of the support body.

The second sheets of insulating material cover the first side region of the support body and are movable relative to the movable contact assembly.

Advantageously, the second sheets of insulating material are stacked one on another along a direction parallel to the connecting rod of the movable contact assembly.

The third sheet of insulating material cover the second side region of the support body.

Preferably, the second sheets of insulating material have a shape complementary to a profile of the support body at the first side region of the support body.

Preferably, the second sheets of insulating material have a free end partially overlapping the third sheet of insulating material in such a way to be interposed between the third sheet of insulating material and the connecting rod.

In the switching pole according to the invention, the baffle arrangement allows conductive parts of the movable contact assembly (especially the connecting braids with the corresponding pole terminal) to be effectively insulated from the actuating rod of the movable contact assembly.

At the same time, the baffle arrangement makes it possible to effectively limit the escape of hot gases from the front window of insulating casing of the switch pole, thus forcing them to pass through the arc chamber. On one hand, this further reduces the probability of undesired arcs forming between the conductive parts of the movable contact assembly and the actuating rod. On the other hand, the development of arcs along the entire arc chamber is favored, which greatly promotes the extinction of the above-mentioned electric arcs.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A switch pole for a low voltage switching device, comprising:
an insulating casing defining an internal space of the switch pole and having opposite front and rear walls, the first and second pole terminals being arranged at the rear wall of the insulating casing;
a fixed contact assembly and a movable contact assembly positioned in the contact region and including, respectively, one or more fixed contacts and one or more movable contacts, which can be mutually coupled or uncoupled, the movable contact assembly being reversibly movable about a rotation axis between a first position, in which the movable contacts are coupled to the fixed contacts, and a second position, in which the movable contacts are spaced apart from the fixed contacts;
wherein the movable contact assembly comprises:
a support body configured to support the movable contacts, the support body having a first side facing the front wall of the insulating casing, and a second side facing the rear wall of the insulating casing, the movable contacts being located at the second side of support body;
a connecting rod fixed to the support body and mechanically coupleable to a driving mechanism of the movable contact assembly outside the switch pole, the connecting rod protruding from the first side of the support body and sticking out of the insulating casing of the switch pole by passing through a front window of the front wall of the insulating casing;
wherein the switch pole comprises a baffle arrangement including one or more sheets of insulating material arranged on the movable contact assembly at the first side of the support body, the one or more sheets of insulating material moving together with the movable contact assembly and being interposed between the support body and the front wall of the insulating casing,
wherein the one or more sheets of insulating material form an insulating dielectric barrier between one or more conductive parts of the movable contact assembly and the connecting rod, and
wherein the one or more sheets of insulating material obstruct at least partially the front window during an opening maneuver of the switching device at least when the movable contact assembly reaches the second position.

2. The switch pole according to claim 1, wherein the one or more sheets of insulating material obstruct at least partially the front window during an opening maneuver of the switching device, also before the movable contact assembly reaches the second position.

3. The switch pole according to claim 1, wherein the baffle arrangement comprises one or more sheets of insulating material fixed to the support body at the first side of the support body.

4. The switch pole according to claim 1, wherein the baffle arrangement comprises one or more sheets of insulating material mounted on the connecting rod at the first side of the support body in such a way to be movable relative to the movable contact assembly.

5. The switch pole according to claim 3, wherein the baffle arrangement comprises a first sheet of insulating material fixed to the support body at the first side of the support body, the first sheet of insulating material having a first sheet portion covering a first side region of the support body, from which the connecting rod protrudes, and a second sheet portion covering a second side region of the support body, at which the conductive parts are arranged.

6. The switch pole according to claim 5, wherein the sheet of insulating material have a shape complementary to a profile of the support body at the first side of the support body.

7. The switch pole according to claim 3, wherein the baffle arrangement comprises:
a plurality of second sheets of insulating material mounted on the connecting rod at the first side of the support body and movable relative to the movable contact assembly, the second sheets of insulating material being stacked one on another along a direction parallel to the connecting rod and covering the first side region of the support body;
a third sheet of insulating material fixed to the support body at the first side of the support body, the third sheet of insulating material covering the second side region of the support body.

8. The switch pole according to claim 7, wherein the second sheets of insulating material have a shape complementary to a profile of the support body at the first side region of the support body.

9. The switch pole according to claim 7, wherein the second sheets of insulating material have a free end partially overlapping the third sheet of insulating material in such a way to be interposed between the third sheet of insulating material and the connecting rod.

10. The switch pole according to claim 1, further comprising an arc chamber positioned in the arc extinguishing region and comprising a plurality of arc-breaking elements.
